(19) United States
(12) Patent Application Publication
(10) Pub. No.: US 2013/0297269 A1
(43) Pub. Date: Nov. 7, 2013

(54) PROCESSING GEOPHYSICAL DATA

(71) Applicants: Mark Davies, Cambridgeshire (GB); Raymond Joseph Matela, Bedforshire (GB)

(72) Inventors: Mark Davies, Cambridgeshire (GB); Raymond Joseph Matela, Bedforshire (GB)

(73) Assignee: ARKeX Limited

(21) Appl. No.: 13/700,039

(22) PCT Filed: May 25, 2011
(86) PCT No.: PCT/GB2011/050985

§ 371 Date: Jul. 18, 2013

(30) Foreign Application Priority Data
May 28, 2010 (GB) 1008993.6
Jun. 24, 2010 (GB) 1010634.2

(51) Int. Cl. G06F 17/50

(52) U.S. Cl. CPC G06F 17/5009
USPC 703/6

(57) ABSTRACT

A method of processing geophysical data from a survey of a surveyed region of the earth to provide a three-dimensional representation of the underlying geology of said surveyed region, the method comprising: inputting geophysical data for said surveyed region, generating an initial three-dimensional representation depicting faults of said underlying geology of said surveyed region using said input geophysical data, calculating the accommodation zone for each depicted fault using geomechanical parameters including at least stress and strain, generating a final three-dimensional representation depicting both faults and accommodation zones.

### FIELD OF THE INVENTION

This invention relates to methods, apparatus, and computer program code for processing geophysical data, for example potential field data from a potential field survey to provide a representation of the underlying geology of the surveyed region.

### BACKGROUND TO THE INVENTION

In this specification we will refer to airborne surveys, and more particularly to gravity gradient surveys. However the techniques we describe are not limited to these types of survey and may be applied to other surveys including other potential field surveys, such as, gravity surveys, magnetic field surveys such as magnetotelluric surveys, electromagnetic surveys and the like.

A potential field survey is performed by measuring potential field data which, for a gravity survey, may comprise one or more of gravimeter data (measuring gravity field) or gravity gradiometer data (measuring gravity field gradient), vector magnetometer data, true magnetic gradiometer data, and other types of data well-known to those skilled in the art. A common aim of a geophysical potential field survey is to search for signatures which potentially indicate valuable mineral deposits.

One such valuable mineral deposit is natural gas held within shale deposits. Typically potential field data such as gravity gradiometry, gravity or magnetic data will not image the subtle faults often encountered when drilling shales and this presents a problem as explained below.

Various techniques for recovering natural gas from shale deposits are known. One popular technique is known as “fracturing” in which large volumes of fluid are used to shatter the shale allowing the natural gas to flow to the well. The success of such a technique is largely dependent on (a) increasing the surface area of shale in contact with the well bore and (b) increasing the degree of fracture within the shale. As shown in FIG. 1a, the shale deposits typically form generally horizontal layers. Horizontal wells following the plane of the shale layer generally yield far more natural gas than a vertical well. However, as shown in FIG. 1a, if the horizontal well punches through the top or bottom bounding interface, a loss of hydraulic fracturing pressure can be experienced as the fluid escapes into juxtaposed, higher permeability layers. The ramification of which is an inability to increase fracture within the shale unit. Accordingly, one of the biggest problems is encountering a shift in stratigraphy due to faulting within the shale unit.

There are various solutions to this problem, including drilling in areas known to have less faulting. As such areas become scarcer, alternative solutions are required. As shown in FIG. 1a, 3D seismic imaging may be used to ensure that when encountering fault planes, the direction of the drill bit is changed so that the drill bit tracks the shale layer through the fault offsets. This is a complex process with a generally high failure rate. Alternatively, as shown in FIG. 1b, a map of the fault planes may be generated and the horizontal wells 150 may be drilled parallel to fault planes. In this case, the problem is solved by applying a directional bias dictated by the regional and local structural fabric.

As shown in FIG. 1b, there is still a problem with drilling parallel to the major fault planes in that the well may pass through a conjugate fault plane 154 which results in a loss of hydraulic pressure. There is a need to identify structurally incomplex zones having no major or conjugate fault zones in which a well 152 may be located having at a plurality of bore holes extending therefrom. The well 152 may be considered to be located at a “sweet spot” in the resource area. The bore holes extend radially around the central point and thus the well is termed a radial well 152.

### STATEMENT OF THE INVENTION

According to a first aspect of the invention, there is provided a method of processing geophysical data from a survey of a surveyed region of the earth to provide a three-dimensional representation of the underlying geology of said surveyed region, the method comprising:
inputting geophysical data for said surveyed region,
generating an initial three-dimensional representation depicting faults of said underlying geology of said surveyed region using said input geophysical data,
calculating the accommodation zone for each depicted fault using geomechanical parameters including at least stress and strain,
generating a final three-dimensional representation depicting both faults and accommodation zones.

According to a second aspect of the invention, there is provided apparatus for processing geophysical data from a survey of a surveyed region of the earth to provide a three-dimensional representation of the underlying geology of said surveyed region, the apparatus comprising:
an input for inputting geophysical data for said surveyed region, and a processor which is configured to
generate an initial three-dimensional representation depicting faults of said underlying geology of said surveyed region using said input geophysical data,
calculate the accommodation zone for each depicted fault using geomechanical parameters including at least stress and strain, and
generate a final three-dimensional representation depicting both faults and accommodation zones.

Both aspects of the invention allow the initial representation derived through the interpretation of geophysical observations to be improved by including the distribution of regions of failure associated with the movement of major faults under a stress condition. In the context of the example of drilling gas within shale layers discussed above, the final three-dimensional representation may be used to locate sweet-spots for inserting radial drills.

The following features apply to both aspects.

Calculating the accommodation zone comprises generating a model of the accommodation zone using finite element analysis or boundary element analysis wherein the model is discretized into a plurality of cells. Whether or not each of the plurality of cells exceeds a failure criterion may be determined. Any known failure criterion may be used and one example of a useful failure criterion may be the Mohr-Coulomb failure envelope

τ=σ tan(φ)+c,

where τ is the shear strength of the material,
c is its cohesion
φ is the angle of internal friction.

The probability of encountering a subtle fault adjacent the depicted faults in the initial three-dimensional representation may be determined from the calculation of the accommodation zone. The final three-dimensional representation may output a map showing the determined probabilities.

According to another aspect of the invention, there is provided a method of extracting gas from shale deposits, the method comprising conducting a survey of a region having shale deposits, using the method described above to generate a final three-dimensional representation of the underlying geology of the surveyed region, and extracting said gas using said three-dimensional representation of said underlying geology.

The aircraft or vessel conducting the survey may be equipped with a range of geophysical measurement equipment including one or more potential field measurement instruments, for example vector gravimeter, gravity gradiometer, magnetometer, magnetic gradiometer or other instruments.

The plane or vessel may be fitted with any of a range of additional standard airborne geophysical survey instrumentation such as instrumentation for: GPS, DGPS, altimeter, altitude measurement, pressure measurement, hyperspectral scanner, an electromagnetic measurement (EM), a Time Domain Electromagnetic system (TDEM), a vector magnetometer, accelerometer, gravimeter, and other devices including other potential field measurement devices.

The outputs from instrumentation may be corrected using instrumentation in a fixed or movable base station, for example according to best practice at the time. Such equipment may include GPS and magnetic instrumentation and high quality land gravimeters. Data collected according to any of the above methods may be combined with any ground based or satellite based survey data to help improve the analysis, such data including terrain, spectral, magnetic or other data.

The invention further provides processor control code to implement the above-described methods, in particular on a data carrier such as a disk, CD- or DVD-ROM, programmed memory such as read-only memory (Firmware), or on a data carrier such as an optical or electrical signal carrier. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

### BRIEF DESCRIPTION OF DRAWINGS

These and other aspects of the invention will now be further described, by way of example only, with reference to the accompanying figures in which:

FIG. 1a is a section showing a schematic cross-section of a well being drilled through a shale layer;

FIG. 1b is a plan view of a project area showing the location of major faults and well heads;

FIG. 2 is a flowchart of the method of mapping accommodation zones around the faults shown in FIG. 1b;

FIG. 3a is a schematic cross-section of an accommodation zone;

FIG. 3b is a schematic drawing showing deformation from compressive strain;

FIG. 3c is a schematic drawing showing deformation from extensional shear strain;

FIG. 4 is a probability map of encountering the accommodation zone of FIG. 3a, and

FIG. 5 is a schematic drawing of a vessel for conducting a survey.

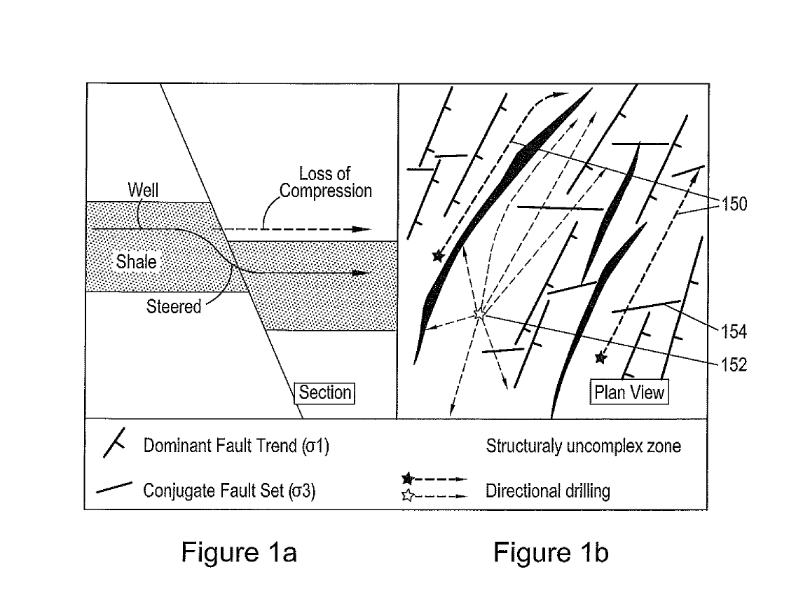

### DETAILED DESCRIPTION OF DRAWINGS

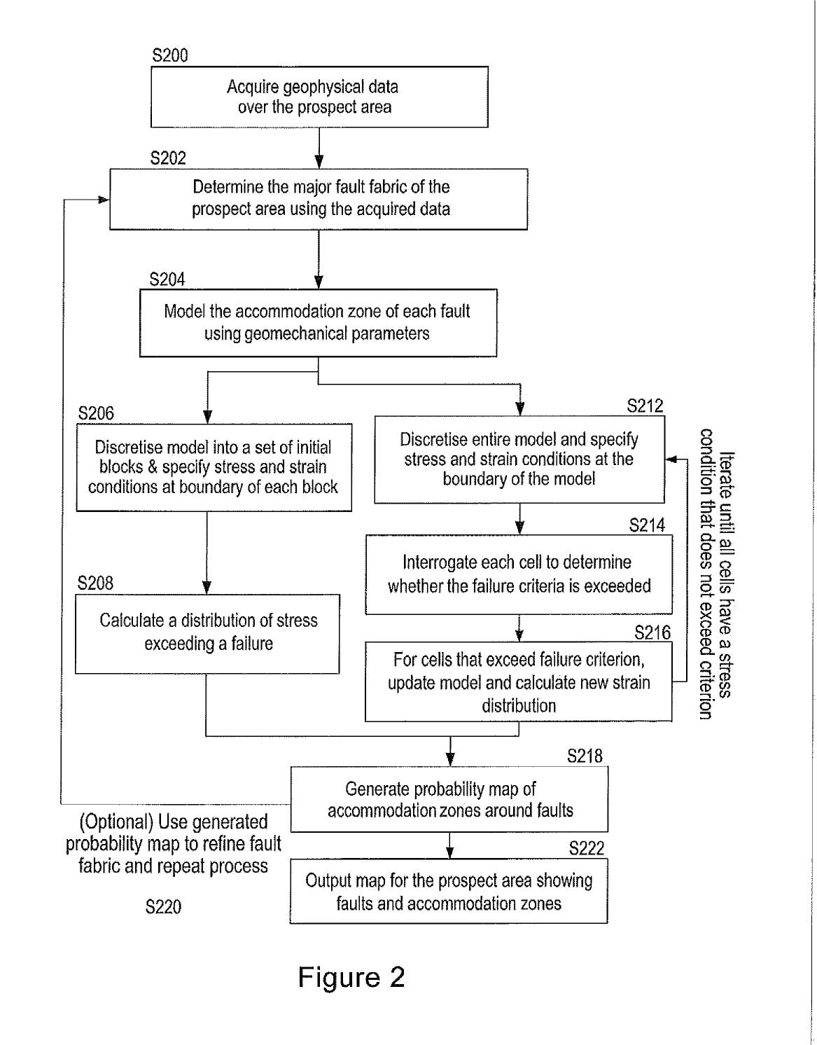

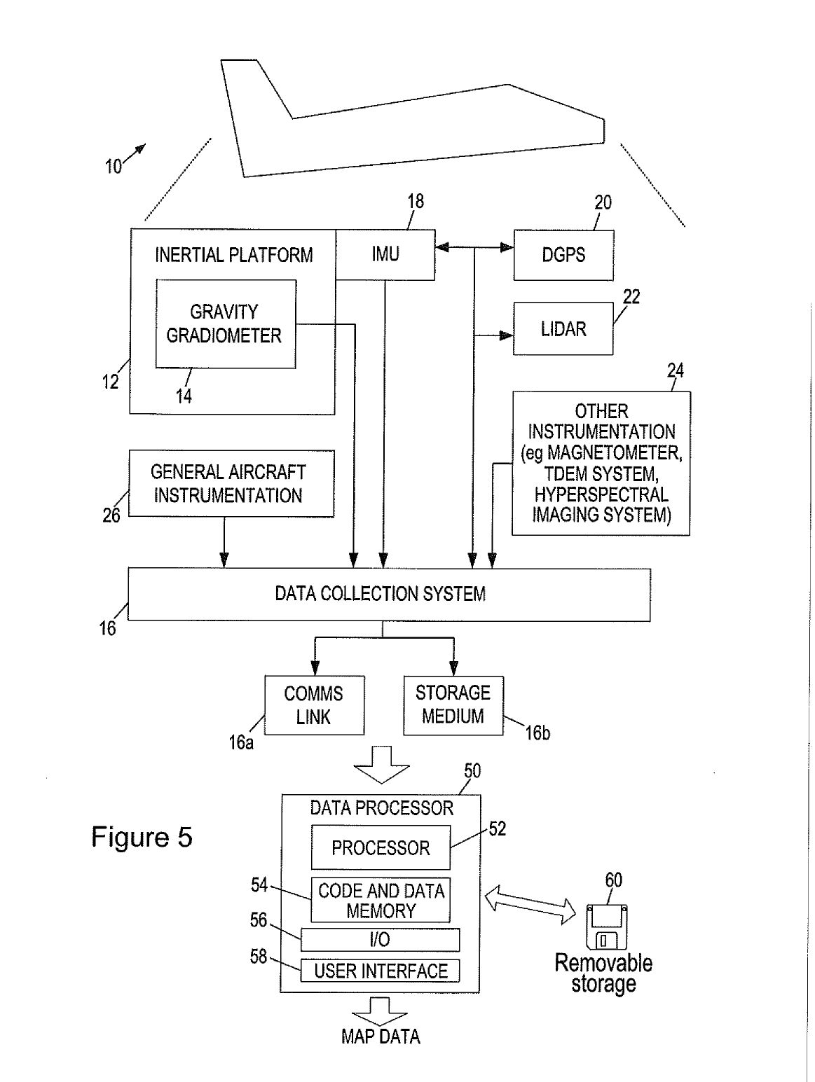

As shown in FIG. 2, the first step S200 is to acquire geophysical data over the prospect area. This may be done from any known platform (both stationary and moving platforms) over any surface. For example, the survey may be a marine or airborne survey, a static survey on land or a satellite survey. The survey may collect a variety of data, including potential field data (see FIG. 5 for more detail). At step S202, a map of the major faults in the prospect area is generated using known techniques, for example using processing techniques developed by the present applicant, including those taught in WO2009/092992, WO2009/016348, WO2008/117081, WO2008/93139, WO2007/085875 and WO2007/012895. In particular, WO2009/016348 describes a method of determining line features such as faults. These applications are all incorporated herein by reference.

For example, as summarised from WO2009/016348, the potential field data is filtered by spatial wavelength to target geology at different depths. Then, the procedure processes vector gravity field components Gₓ, G_{y} and G_{z} to determine line features and dilate the determined interpretation lines to represent an approximate error margin, for example 100 metres. The procedure next processes gravity gradient components Gₓₓ, G_{yy} and G_{zz}, again to determine lines for interpreting the underlying geology. Preferably a single dilation value is used for all the interpretation lines—that is in embodiments of the method the widths of the interpretation lines derived from different potential fields/potential field components are substantially the same. As can be seen, the G_{zz} signal provides a sharper representation of the subterranean body than G_{z}.

The procedure then processes gravity gradient components G_{zx} and G_{zy}, in these cases to identify points/lines defining maxima or minima (closely spaced maxima/minima may be joined to form lines). The procedure processes G_{xy} to determine point/line features and dilates these to represent errors. Maxima/minima points are determined and trend lines between these points to locally divide maxima from minima are added. Such a trend line is preferably only added when there is greater than a threshold difference between the maximum and an adjacent minimum. This is because the G_{xy} signal tends to pick out the corners of a subterranean body.

Preferably all the gravity gradient tensor components are employed, to make best use of the available information. Preferably, where available, the procedure then continues to process RTP magnetic data, and optionally other survey data where available, again to identify point/line features representing the underlying geology of the surveyed region. Once a plurality of sets of spatial features have been identified, these are combined and a degree of correlation or coherency between the available sets of spatial features is determined, in particular from the tensor components of the gravity gradient data and from the vector components of the gravity field and/or magnetic data.

At step S204, once the major fault fabric is determined, geomechanical techniques are used to predict the region of disruption around those major faults. This zone of disruption may be termed an accommodation or dilation zone and represents the volume within which the displacement of the fault is accommodated, recognising that a fault is not restricted to a single shear plane but a collection of slip surfaces.

At step S204, the accommodation zone is mapped using geomechanical parameters and modern rock mechanics theory. The tensile stress and strain ratios of all lithological components may be considered. There are various methods having varying degrees of precision. Two alternative 3D techniques are shown in FIG. 2. It is also possible that a simple model may be constructed using the stress tensor within the model, and the strength parameters of the rock. There are many known models and one example is given below:

The model is known as the Mohr-Coulomb failure envelope τ=σ tan (φ)+c,

where τ is the shear strength of the material,
c is its cohesion
φ is the angle of internal friction.

Such a model yields a region defined by the predicted angle of failure of the material in the model. This approach will become difficult to apply sufficiently accurately where the major fault fabric becomes complex, for instance where the accommodation zones for each major fault overlap or the major faults themselves intersect. In this situation a 3D solution is required. This may be derived using 3D structural modelling software such as static or dynamic Finite Element or Boundary Element Methods depending on the structural complexity being modelled.

Finite and Boundary Element modelling are well established methods in the civil engineering sector (e.g. SL Crouch and AN Starfield, Unwin Hyman ISBN 0-04-620010-x ISBN 0-04-445913 0 1990 for boundary element modelling in solid mechanics). Steps S206 and S208 summarises the key steps in a boundary element model. At step S206, the model is discretised into a set of initial blocks and the stress and strain conditions at the boundary of each block are specified. The stress and strain within each competent block is then calculated analytically and a distribution of stress exceeding a failure criterion (e.g. the Mohr Coulomb failure condition described above or alternate specifications of failure) is developed (S208). In this way a model is constructed to identify the boundary of failure to be identified. However, updating to model the stress—strain condition after failure is difficult, so development of a more precise failure pattern requires a Finite Element approach.

Steps S212 to S216 summarises the key steps in a finite element approach. In the first step S212, the entire model is discretised and the stress and strain conditions at the boundary of the model are specified. At step S214, each cell is interrogated to detect whether the failure criteria (e.g. the Mohr Coulomb failure condition described above or alternate specifications of failure) are exceeded. At step S216, for cells that exceed the failure criterion the model is structurally updated to allow the failed strength to replace the competent strength and a new strain distribution to be computed. This process is iterated until all cells in the model have a stress condition that does not exceed the failure criterion.

The probability map of accommodation zone may be calculated from either step s208 or s216 using a range of different techniques. For example, using the boundary element analysis method, a distribution of blocks having stress exceeding a failure criterion is generated at it is those blocks in the criterion is exceeded that a fault is likely to be present. The relative probability of a fault may, for example, be determined from the number of adjacent blocks in which the failure criterion is exceeded (depending, for example, on the end state of the iteration procedure and/or what end state condition is employed and/or how the end state is determined).

Whether boundary element analysis or finite element analysis is used, the output is a map showing the probability of an accommodation zone being present around the primary imaged fault determined in step S202. An optional step S220 is to use the output probability map to refine the initial representation of the major fault fabric and to repeat the process of generating a probability map. This iterative process can be repeated one or more (several) times to improve the output, in embodiments feeding back the accommodation zone probability map into the system.

Finally, the map for the prospect area showing both faults and accommodation zones is output.

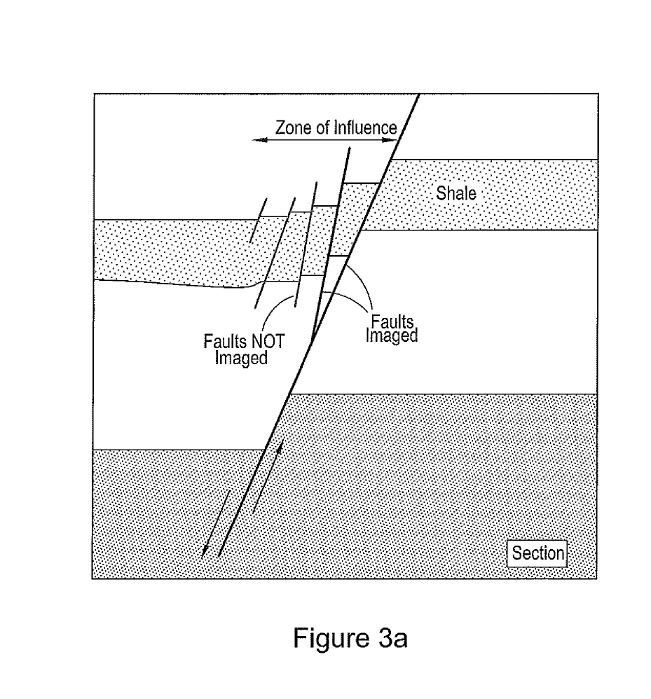

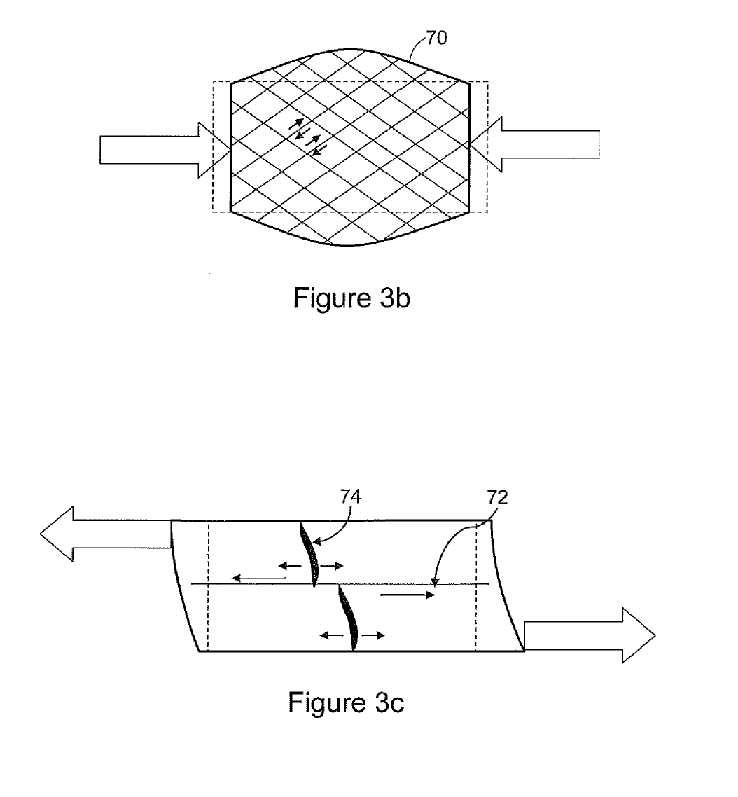

FIG. 3a shows a major fault and its accommodation zone marked as the zone of influence in. Within the zone of influence, one or more faults may be imaged using the geophysical data as described in steps S200 and S202. However, some faults are not imaged using conventional techniques. The accommodation zone is the region within which a linear borehole will intersect slip surfaces which individually act to accommodate a portion of the total strain on the fault.

The major fault fabric described is that whose component fault surfaces extend throughout the depth range of interest. These faults are likely to be continuations of, or reactions to the strain induced by, faults in the deeper section of the earth which are responding to tectonic scale stress fields. Therefore these faults will be associated by position, style and direction with the faults in the underlying competent rock referred to as ‘basement’ faults. Alternatively, the faults may be salt detached fault systems which are formed when one or more salt layers are present and extensional faults propagate up from the middle part of the crust until they encounter these layer. The weakness of the salt layer prevents the fault from propagating through but continuing displacement on the fault offsets the base of the salt and causes bending of the overburden layer which eventually faults.

The Earth's crust is a complex assembly of materials with varying strengths, spatially varying stress conditions. Faults do not extend indefinitely in either lateral or vertical directions, rather they must terminate in some way at a zero deformation condition. A tectonic stress field acting on the assembly will lead to the development of a set of major fractures (the so called basement faults) in the strongest material (that most resistant to strain) and a set of associated fractures that allow the material surrounding the strong material to deform to accommodate the imposed strain.

As shown in FIGS. 3b and 3c, the strain imposed on a portion of the earths crust is not necessarily arranged in a simple linear shape. Where a curved strain field is imposed it is likely to be accommodated by a complex arrangement of intersecting faults. The pattern of faults associated with compressive strain shown in FIG. 3b is often referred to as a conjugate fault set 70. As shown in FIG. 3c, tension or extensional shear strain is normally accommodated by a combination of normal faulting 72 and strike slip faulting 74.

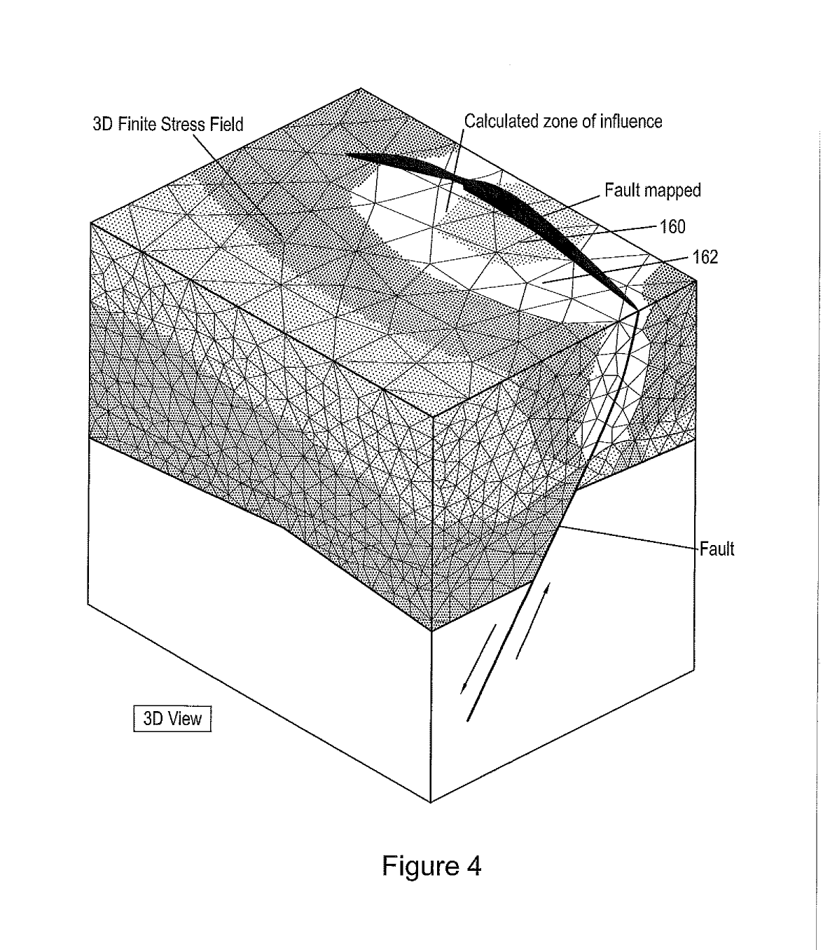

The calculation of the accommodation zone can be used to determine the probability of encountering a non-imaged fault (e.g. a subtle fault) adjacent the faults depicted in the initial 3-D representation from the field data. As shown in FIG. 4, these probabilities may be output in the final 3-D representation. The primary imaged fault which is itself evident in the field data is depicted as a solid black area with the calculated zone of influence shown in different shades to show the difference in probability of hitting a subtle accommodating fault. There is a generally circular area 160 at the widest point of the fault in which there is the highest probability of encountering a non-imaged fault (i.e. where probability exceeds a high threshold of perhaps 80 or 90%). A larger area 162 surrounding the central circular area has a lower (but still relatively high, e.g. 50-70%) probability of encountering a subtle fault. Outside these two areas, there is a low probability of encountering a subtle fault. The areas may be colour coded with “hotter” colours (e.g. red, orange) showing high probability and “cooler” colours (e.g. green, blue) showing lower probability. The lower probability areas may be considered to be the areas of low structural complexity and are thus the preferred areas to target for wells. In these areas, radial wells may be drilled successfully thus maximising yields.

Referring now to FIG. 5, this shows an example of an aircraft 10 for conducting a potential field survey to obtain data for processing in accordance with a method as described above. As set out above, the survey may also be a marine survey in which case the aircraft may be replaced by a boat. The aircraft 10 or other vessel for conducting the survey comprises an inertial platform 12 on which is mounted a gravity gradiometer 14 (and/or vector magnetometer) which provides potential field survey data to a data collection system 16. The inertial platform 12 is fitted with an inertial measurement unit (IMU) 18 which also provides data to data collection system 16 typically comprising attitude data (for example, pitch, roll and yaw data), angular rate and angular acceleration data, and aircraft acceleration data. The aircraft is also equipped with a differential GPS system 20 and a LIDAR system 22 or similar to provide data on the height of the aircraft above the underlying terrain. Position and time data are preferably obtained from (D)GPS, optionally in combination with the IMU for accuracy.

The aircraft 10 may also be equipped with other instrumentation 24 such as a magnetometer, a TDEM (Time Domain Electromagnetic System) system and/or a hyperspectral imaging system, again feeding into the data collection system. The data collection system 16 also has an input from general aircraft instrumentation 26 which may comprise, for example, an altimeter, air and/or ground speed data and the like. The data collection system 16 may provide some initial data pre-processing, for example to correct the LIDAR data for aircraft motion and/or to combine data from the IMU 18 and DGPS 20. The data collection system 16 may be provided with a communications link 16a and/or non-volatile storage 16b to enable the collected potential field and position data to be stored for later processing. A network interface (not shown) may also be provided.

Data processing to generate map data for the potential field survey is generally (but not necessarily) carried out offline, sometimes in a different country to that where the survey data was collected. As illustrated a data processing system 50 comprises a processor 52 coupled to code and data memory 54, an input/output system 56 (for example comprising interfaces for a network and/or storage media and/or other communications), and to a user interface 58 for example comprising a keyboard and/or mouse. The code and/or data stored in memory 54 may be provided on a removable storage medium 60. In operation the data includes data collected from the potential field survey and the code comprises code to process this data to generate map data.

Potential field data includes, but is not limited to, gravimeter data, gravity gradiometer data, vector magnetometer data and true magnetic gradiometer data. Such data is characterised mathematically by a series of relationships which govern how the quantities vary as a function of space and how different types of measurement are related. The choice of instrumentation comes down simply to which instrument measures the desired quantity with the largest signal to noise. Elements and representations of a potential field may be derived from a scalar quantity.

For gravity, the relevant potential is the gravity scalar potential, Φ(r), defined as

$$Φ ( r ) = \int \int \int \frac{G ρ ( {r}^{′} )}{\vert r - {r}^{′} \vert} {d}^{3} {r}^{′}$$

Where r, ρ(r′), G are respectively, the position of measurement of the gravity field, the mass density at location r′, and the gravitational constant. The gravitational force, which is how the gravitational field is experienced, is the spatial derivative of the scalar potential. Gravity is a vector in that it has directionality as is well known—gravity acts downwards. It is represented by three components with respect to any chosen Cartesian coordinate system as:

$$g = ( {g}_{x} , {g}_{y} , {g}_{z} ) = ( \frac{\partial Φ ( r )}{\partial x} , \frac{\partial Φ ( r )}{\partial y} , \frac{\partial Φ ( r )}{\partial z} )$$

Each of these three components varies in each of the three directions and the nine quantities so generated form the Gravity gradient tensor:

$$G = ( \begin{matrix}{G}_{xx} & {G}_{xy} & {G}_{xz} \\ {G}_{yx} & {G}_{yy} & {G}_{yz} \\ {G}_{zx} & {G}_{zy} & {G}_{zz}\end{matrix} ) = ( \begin{matrix}\frac{\partial }{\partial x} \frac{\partial Φ ( r )}{\partial x} & \frac{\partial }{\partial x} \frac{\partial Φ ( r )}{\partial y} & \frac{\partial }{\partial x} \frac{\partial Φ ( r )}{\partial z} \\ \frac{\partial }{\partial y} \frac{\partial Φ ( r )}{\partial x} & \frac{\partial }{\partial y} \frac{\partial Φ ( r )}{\partial y} & \frac{\partial }{\partial y} \frac{\partial Φ ( r )}{\partial zx} \\ \frac{\partial }{\partial z} \frac{\partial Φ ( r )}{\partial x} & \frac{\partial }{\partial z} \frac{\partial Φ ( r )}{\partial y} & \frac{\partial }{\partial z} \frac{\partial Φ ( r )}{\partial z}\end{matrix} )$$

The mathematical theory of potential fields is well established—the fundamental equations and relationships follow from analysis of the properties of the scalar potential function, its derivatives, its Fourier transforms and other mathematical quantities.

No doubt many other effective alternatives will occur to the skilled person. It will be understood that the invention is not limited to the described embodiments and encompasses modifications apparent to those skilled in the art lying within the spirit and scope of the claims appended hereto.

1. A computer-implemented method of processing geophysical data from a survey of a surveyed region of the earth to provide a three-dimensional representation of the underlying geology of said surveyed region, the method comprising:
inputting, to a processor, geophysical data for said surveyed region,
generating, using said processor, an initial three-dimensional representation depicting faults of said underlying geology of said surveyed region using said input geophysical data,
calculating, using said processor, an accommodation zone for each depicted fault using geomechanical parameters including at least stress and strain, wherein said accommodation zone represents a volume within which displacement of the fault is accommodated,
generating, using said processor, a final three-dimensional representation depicting both faults and accommodation zones.

2. A method according to claim 1, wherein calculating the accommodation zone comprises generating a model of the accommodation zone using finite element analysis wherein the model is discretized into a plurality of cells.

3. A method according to claim 1, wherein calculating the accommodation zone comprises generating a model of the accommodation zone using boundary element analysis wherein the model is discretized into a plurality of cells.

4. A method according to claim 2, wherein calculating the accommodation zone comprises determining whether or not each of the plurality of cells exceeds a failure criterion.

5. A method according to claim 1, wherein calculating the accommodation zone comprises determining the probability of encountering a subtle fault adjacent the depicted faults in the initial 3-D representation and wherein generating the final three-dimensional representation comprises output a map showing the determined probabilities.

6. A method according to claim 1, comprising inputting geophysical data comprising potential field data.

7. A method according to claim 6, comprising inputting gravity gradient data.

8. A method of extracting gas from shale deposits, the method comprising conducting a survey of a region having shale deposits, using the method of claim 1 to generate a final three-dimensional representation of the underlying geology of the surveyed region, and extracting said gas using said three-dimensional representation of said underlying geology.

9. A non-transitory carrier carrying processor control code to when running on a processor implement the method of claim 1.

10. Apparatus for processing geophysical data from a survey of a surveyed region of the earth to provide a three-dimensional representation of the underlying geology of said surveyed region, the apparatus comprising:
an input for inputting geophysical data for said surveyed region, and
a processor which is configured to
generate an initial three-dimensional representation depicting faults of said underlying geology of said surveyed region using said input geophysical data,
calculate the accommodation zone for each depicted fault using geomechanical parameters including at least stress and strain, and
generate a final three-dimensional representation depicting both faults and accommodation zones.
